(19) United States
(12) Patent Application Publication
(10) Pub. No.: US 2004/0246516 A1
(43) Pub. Date: Dec. 9, 2004

(54) Hard imaging systems, hard imaging management devices, hard imaging devices, articles of manufacture, hard imaging device operational methods, and hard imaging device configuration methods

(76) Inventors: Curtis Reese, Boise, ID (US); Gregory E. Nutt, San Jose (CR)

Correspondence Address: HEWLETT-PACKARD COMPANY, Intellectual Property Administration, P.O. Box 272400, Fort Collins, CO, 80527-2400, US

(21) Appl. No.: 10/454,131

(22) Filed: Jun. 3, 2003

(51) Int. Cl. G06F 9/44; G06F 15/00

(52) U.S. Cl. 358/1.15; 717/170

(57) ABSTRACT

Hard imaging systems, hard imaging management devices, hard imaging devices, articles of manufacture, hard imaging device operational methods, and hard imaging device configuration methods are described. According to one aspect, a hard imaging system includes a plurality of hard imaging devices individually comprising a communications interface configured to communicate with a communications medium external of the respective hard imaging device, an image engine configured to form hard images using media, a file system configured to store a plurality of electronic files, and processing circuitry configured to access the electronic files of the file system during the formation of the hard images, and a management device comprising a communications interface configured to communicate with the communications medium and the hard imaging devices, processing circuitry configured to access and to modify the file systems of the respective hard imaging devices.

### FIELD OF THE INVENTION

Aspects of the invention relate to hard imaging systems, hard imaging management devices, hard imaging devices, articles of manufacture, hard imaging device operational methods, and hard imaging device configuration methods.

### BACKGROUND OF THE INVENTION

Computer systems including personal computers, workstations, hand held devices, etc. have been utilized in an increasing number of applications at home, the workplace, educational environments, entertainment environments, etc. Peripheral devices of increased capabilities and performance have been developed and continually improved upon to extend the functionality and applications of computer systems. For example, imaging devices, such as printers, have experienced significant advancements including refined imaging, faster processing, and color reproduction.

Some imaging device configurations have become more sophisticated as the functionality and performance increase. These devices may utilize programming, such as firmware, to implement various imaging operations. Occasionally, it may be desired to update programming of the devices. Updating may be overly time consuming and/or costly depending upon the configuration of the device to be modified. For example, if the update process is implemented as firmware within read only memory (ROM), updating may necessitate replacement of the ROM devices (e.g., DIMMs). From a manufacturing standpoint, an accurate number of ROMs to be replaced is determined as accurately as possible, but too many devices may be ordered resulting in wasted pieces, or an insufficient number may be ordered resulting in relatively small batches of the devices. Further, the devices are shipped to the locations of the imaging devices and manually installed device-by-device incurring additional inconvenience or cost.

Aspects described herein provide improved hard imaging methods, and hard imaging devices and systems.

### DESCRIPTION OF THE DRAWINGS

FIG. 1 is a functional block diagram of a hard imaging system according to one embodiment.

FIG. 2 is a functional block diagram of a hard imaging management device according to one embodiment.

FIG. 3 is a functional block diagram of a hard imaging device according to one embodiment.

FIG. 4 is a flow chart of a methodology executable by a hard imaging device according to one embodiment.

FIG. 5 is a flow chart of a methodology executable by a hard imaging management device according to one embodiment.

### DETAILED DESCRIPTION OF THE INVENTION

According to one aspect, a hard imaging system includes a plurality of hard imaging devices individually comprising a communications interface configured to communicate with a communications medium external of the respective hard imaging device, an image engine configured to form hard images using media, a file system configured to store a plurality of electronic files, and processing circuitry configured to access the files of the file system during the formation of the hard images, and a management device comprising a communications interface configured to communicate with the communications medium and the hard imaging devices, processing circuitry configured to access and to modify the file systems of the respective hard imaging devices.

According to another embodiment, a hard imaging management device comprises a communications interface configured to communicate with a communications medium and a hard imaging device external of the hard imaging management device and coupled with the communications medium, wherein the hard imaging device is configured to form hard images using media and processing circuitry configured to access a file system of the hard imaging device, and to modify at least a portion of the file system of the hard imaging device, wherein the modification is pertinent to hard imaging operations of the hard imaging device for forming the hard images.

According to an additional embodiment, a hard imaging device comprises a communications interface configured to communicate with a communications medium external of the hard imaging device, an image engine configured to form hard images using media, a file system comprising a plurality of electronic files pertinent to hard imaging operations of the hard imaging device for forming the hard images using the image engine, and processing circuitry configured to implement communications operations of the hard imaging device with respect to a hard imaging management device coupled with the communications medium, wherein the processing circuitry is configured to output data regarding the file system to the hard imaging management device and to modify the file system responsive to a communication received from the hard imaging management device.

According to another additional embodiment, a hard imaging device comprises imaging means for hard imaging images using media, storage means for storing a file system comprising a plurality of electronic files pertinent to hard imaging operations of the hard imaging device forming the hard images using media, and processing means for implementing communications externally of the hard imaging device including outputting data regarding the file system and receiving a communication originating externally of the hard imaging device, and for modifying the file system responsive to the communication.

According to another embodiment, an article of manufacture comprises processor-usable media comprising programming configured to cause processing circuitry of a hard imaging device to output data regarding a file system comprising a plurality of electronic files externally of the hard imaging device, access a communication originating from externally of the hard imaging system, modify the file system responsive to the accessed communication, and control a hard imaging operation of the hard imaging device for forming a hard image using the modified file system.

According to another embodiment, a hard imaging device operational method comprises providing a hard imaging device comprising a file system pertinent to forming hard images using the hard imaging device, communicating data regarding the file system externally of the hard imaging device, receiving a communication within the hard imaging device responsive to the communicating, processing the communication using the hard imaging device, modifying the file system responsive to the processing of the received communication using the hard imaging device, accessing a portion of the file system using the hard imaging device after the modifying, and forming hard images according to the accessed portion of the file system using the hard imaging device.

According to still another embodiment of the invention, a hard imaging device configuration method comprises providing a hard imaging device configured to form hard images upon media, providing a hard imaging management device, coupling the hard imaging device and the hard imaging management device in an arrangement permitting communication of data between the hard imaging device and the hard imaging management device, and mounting a file system of the hard imaging device using the hard imaging management device.

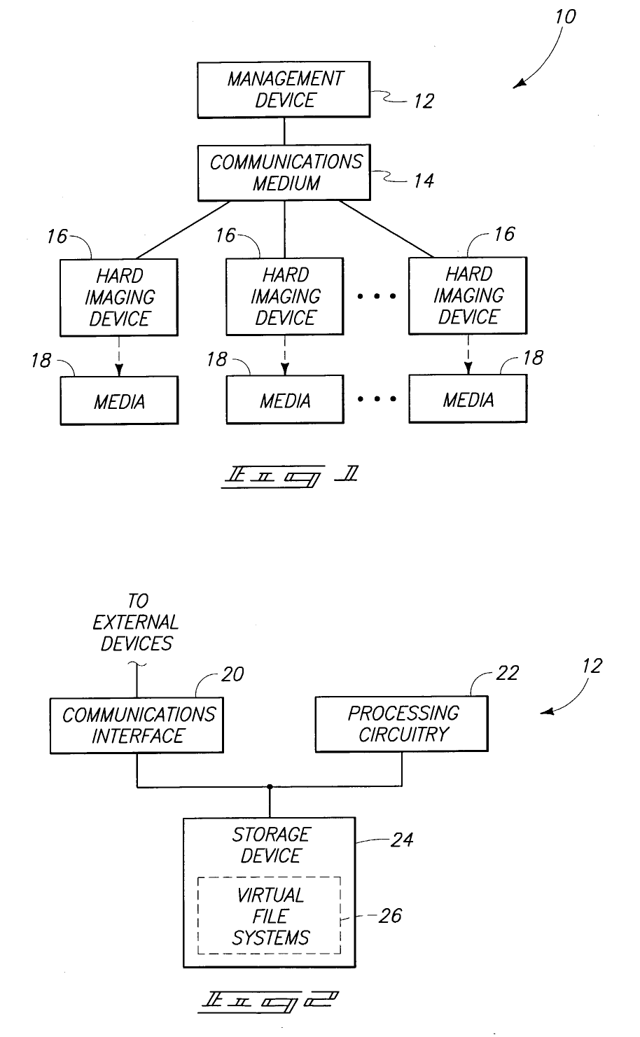

Referring to FIG. 1, an exemplary hard imaging system 10 arranged according to one embodiment is shown. The depicted hard imaging system 10 includes a hard imaging management device 12, a communications medium 14, and one or more hard imaging device 16. In one arrangement, at least some of devices 12, 16 are provided at locations physically separated from one another.

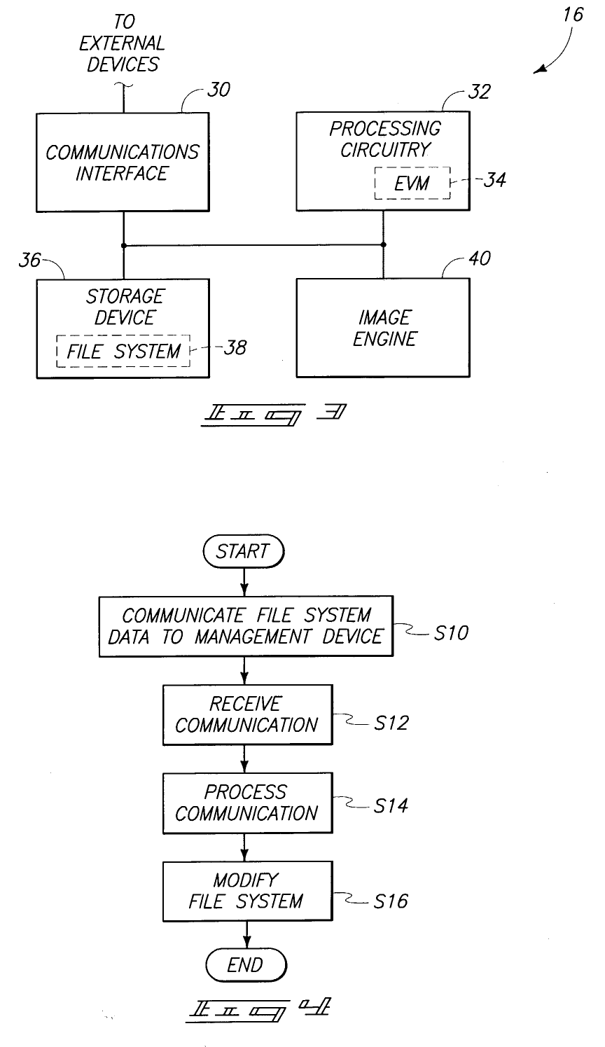

Hard imaging management device 12 is configured to monitor hard imaging devices 16 and reconfigure or otherwise modify hard imaging devices 16 as described further below. Hard imaging management may be implemented using either “push” or “pull” technology in the sense that one device, either device 12 or device 16, actively controls the interaction (the client) and the other device, either device 12 or device 16, provides the functionality (the server). Hard imaging management device 12 may be configured as a server, such as a web-enabled server, in one arrangement. Other configurations of hard imaging management device 12 are possible where device 12 may function as either a client of device 16 or a server for device 16. Further details regarding an exemplary configuration of management device 12 are described below with respect to FIG. 2.

Communications medium 14 is configured to implement bi-directional communications between management device 12 and individual ones of hard imaging devices 16. Either device 12 or device 16 may act as a server in such bi-direction communication. Communications medium 14 may be configured in any suitable manner to provide communication of electronic data, programming or other information between coupled devices. For example, communications medium 14 may comprise private and/or public networked components. Communications medium 14 may also be a virtual private network incorporating either push or pull logic to bypass security boundaries, such as a firewall, between device 12 and device 16. Communications medium 14 could also represent a point-to-point communication such as with a directly connected printer. For such a directly connected printer, the communication could be through serial connection, parallel connection, Universal Serial Bus (USB), etc.

Hard imaging devices 16 are configured to form hard images and/or to manage virtual images. Hard images comprise images physically rendered upon output media 18, such as sheet paper, roll paper, envelopes, transparencies, labels, etc. Virtual images refer to electronic images that may be retained, managed, and may or may not be rendered as hard images or multiple copies of hard images at a later date. Hard imaging devices 16 may be implemented as laser printers, inkjet printers, impact printers, copiers, facsimile devices, multiple function peripheral (MFP) devices, or any other configuration arranged to form hard images. Hard imaging devices 16 may have the same or different configurations in a given implementation of system 10. Additional details regarding an exemplary configuration of one of hard imaging devices 16 are described below with respect to FIG. 3.

Referring to FIG. 2, further details of an exemplary hard imaging management device 12 are shown. The illustrated management device 12 comprises a communications interface 20, processing circuitry 22, and a storage device 24.

Communications interface 20 is configured to communicate electronic data externally of management device 12, for example, with respect to communications medium 14 and devices 16. In one embodiment, interface 20 is arranged to provide input/output communications with respect to external devices, such as hard imaging devices 16. Interface 20 may comprise a parallel port, USB port, Enhanced Input/Output (EIO) interface available from the Hewlett-Packard Company, network interface card (e.g., JetDirect™), IEEE 1394 connector, and/or other appropriate configuration capable of communicating electronic data.

Processing circuitry 22 is configured to process data and control management operations of hard imaging system 10. In one embodiment, processing circuitry 22 may comprise circuitry configured to execute provided programming. For example, processing circuitry 22 may be implemented as a microprocessor or other structure configured to execute executable instructions of programming including, for example, software and/or firmware instructions. Other exemplary embodiments of processing circuitry 22 include hardware logic, PGA, FPGA, ASIC, and/or other structures. These examples of processing circuitry 22 are for illustration and other configurations are possible for implementing operations discussed herein.

Storage device 24 is configured to store electronic data, programming such as executable instructions (e.g., software and/or firmware), and/or other digital information and may include processor-usable media. Processor-usable media includes any article of manufacture that can contain, store, or maintain programming, data and/or digital information for use by or in connection with an instruction execution system including processing circuitry in the exemplary embodiment. For example, exemplary processor-usable media may include any one of physical media such as electronic, magnetic, optical, electromagnetic, infrared or semiconductor media. Some more specific examples of processor-usable media include, but are not limited to, a portable magnetic computer diskette, such as a floppy diskette, zip disk, hard drive, random access memory, read only memory, flash memory, cache memory, and/or other configurations capable of storing programming, data, or other digital information.

As illustrated in the depicted example, storage device 24 is configured to store data regarding a file system (e.g., reference character 38 of FIG. 3) of one or more of hard imaging devices 16. Representations of file systems 38 may be provided and referred to as virtual file systems 26. Individual virtual file systems 26 may correspond to respective individual file systems 38 of hard imaging devices 16. Storage device 24 may or may not reside in the same physical location as either processing circuitry 22 and/or hard imaging device 16, or in the same housing of device 16.

Virtual file systems 26 may be provided by logically mounting file systems 38 using management device 12 in one embodiment. Other implementations for accessing or representing file systems 38 of hard imaging devices 16 are possible (e.g., file system mapping). As described in detail below, management device 12 is configured to modify file systems 38 of one or more hard imaging device 16 using virtual file systems 26 according to illustrative aspects.

FIG. 3 shows an exemplary configuration of hard imaging device 16. Hard imaging device 16 comprises a communications interface 30, processing circuitry 32, storage device 36, and an image engine 40. The depicted example of hard imaging device 16 comprises a printer for discussion purposes. Other implementations are possible as mentioned previously.

Communications interface 30 is configured to communicate electronic data externally of hard imaging device 16. In one embodiment, interface 30 is arranged to provide input/output communications with respect to external devices (e.g., management device 12), via for example, communications medium 14. Interface 30 may be configured similarly to communications interface 20 of management device 12 in one embodiment.

Processing circuitry 32 is configured to process image data and control operations of hard imaging device 16 (e.g., communications, imaging, etc.). Processing circuitry 32 may comprise circuitry configured to implement desired programming (e.g., a microprocessor or other structure configured to execute software and/or firmware instructions. Other exemplary embodiments of processing circuitry 32 include hardware logic, PGA, FPGA, ASIC, and/or other processing structures. These examples of processing circuitry are for illustration and other configurations are possible for processing image data and controlling operations of hard imaging device 16.

In one embodiment, processing circuitry 32 may execute programming of an embedded virtual machine (EVM) 34. In one example, the embedded virtual machine 34 is a real-time interpreter configured to create executable bytecode responsive to an executable application (e.g., applet) received from an external source (e.g., management device 12). One possible embedded virtual machine program includes a passive server such as an Embedded Web Server (EWS) as well as active client logic implemented on a Java Virtual Machine (JVM). Other client or server embodiments are possible.

Storage device 36 is configured to store electronic data, programming such as executable instructions (e.g., software and/or firmware), and/or other digital information and may include articles of manufacture including processor-usable media described previously.

According to exemplary arrangements described herein, storage device 36 is configured to store a file system 38 comprising a plurality of electronic files. At least some of the files may be pertinent to hard imaging operations of the respective hard imaging device 16. During hard imaging operations of hard imaging devices 16, respective processing circuits 32 may access electronic files of the respective file system 38. For example, exemplary files include fonts, electronic forms having modifiable fields, signature files, executable applications, programming supporting operation of the device 16 (e.g., software modules, firmware modules, etc.), virtual images, and other electronic data usable by hard imaging device 16 to implement the formation of hard images and other functionality of device 16. In one example, virtual file systems 26 and respective file systems 38 are located in different physical locations (i.e., within device 12 and respective individual devices 16 in the illustrated example).

Image engine 40 is configured to form hard images upon output media 18 (FIG. 1). In one embodiment, image engine 40 comprises development and fusing assemblies configured to form the hard images using a marking agent, such as toner or ink. Image engine 40 may be configured to generate monochrome and/or color hard images and/or virtual images. In exemplary printer embodiments of device 14, image engine 40 comprises a print engine. In other embodiments of device 14, image engine 40 represents a print server that manages virtual images.

According to exemplary embodiments, management device 12 is configured to access, manage and/or modify file systems 38 of individual hard imaging devices 16. In one implementation, management device 12 may operate to logically mount the file systems 38 to provide the accessing, management, and/or modification. In another embodiment, hard image device 16 may also operate to logically mount the file systems 26 to receive modifications. Exemplary accessing includes obtaining a layout (e.g., directory tree) of the file systems 38 indicating directories, subdirectories, and contents (e.g., electronic files) of the directories and subdirectories as well as accessing the directories, subdirectories and contents. Exemplary management and modification include creating/deleting directories, moving contents intermediate directories and/or subdirectories, copying new files or directories or subdirectories, or modifying existing files using the virtual file systems 26.

In some configurations, management device 12 may communicate electronic files comprising executable applications (e.g., applets) to one or more of hard imaging devices 16. In one embodiment, processing circuitry 32 of a recipient hard imaging device 16 may recognize the executable application and automatically execute the provided executable application without user intervention. In another embodiment, manual intervention initiates execution of an executable application.

In some arrangements of system 10, at least some of hard imaging devices 16 may comprise the same or similar device configuration (e.g., LaserJet® model laser printer available from the Hewlett-Packard Company). Accordingly, at least some of hard imaging devices 16 may have the same or similar file systems 38. In one embodiment, management device 12 is configured to implement management and/or modification operations in a single batch operation. Batch operations may be used to copy new files and/or modify existing files or perform other desired operations of the appropriate file systems 38 of plural devices 16 in one embodiment.

The described access, management and modification operations are provided to illustrate some aspects of system 10. Other operations by management device 12 and/or hard imaging devices 16 may be performed with respect to virtual file systems 26 and respective file systems 38 according to other aspects.

As mentioned previously, the accessing, management and/or modification of file systems 38 by management device 12 may be implemented in different ways. For example, mounting using an appropriate protocol is possible or file system mapping of the files systems 38 of hard imaging devices 16 to management device 12 may be used or mapping for file systems 26 to hard image device 16 may be used. File systems 26 and 38 and devices 12 and 16 can be at the same or different physical locations. Other methodologies may be used in other embodiments. The discussion proceeds below to illustrate additional details with respect to one possible configuration wherein mounting of file systems 38 is used.

In the described exemplary configuration, management device 12 and hard imaging device 16 are configured to implement mounting using network protocol programming. More specifically, a distributed-file-system protocol, such as Network File System (NFS), permits management device 12 to access, manage, and/or modify file systems 38 of hard imaging devices 16 using mounted file systems 26. In one NFS implementation, management device 12 includes a remote file system client module which supports communication with remotely located file system 38. Management device 12 may also utilize a logical file system mount to assist with mounting operations in an exemplary NFS embodiment. Hard imaging device 16 may comprise a remote file system server module to support exemplary mounting operations. Additional exemplary mounting operations of a file system from one device to another device are described in a commonly assigned U.S. patent application naming Curtis Reese, William A. Cox, and Gregory Nutt as inventors, having Ser. No. 10/350,577, entitled “Printer with Access to Remote Filing System,” filed Jan. 24, 2003, and the teachings of which are incorporated by reference herein.

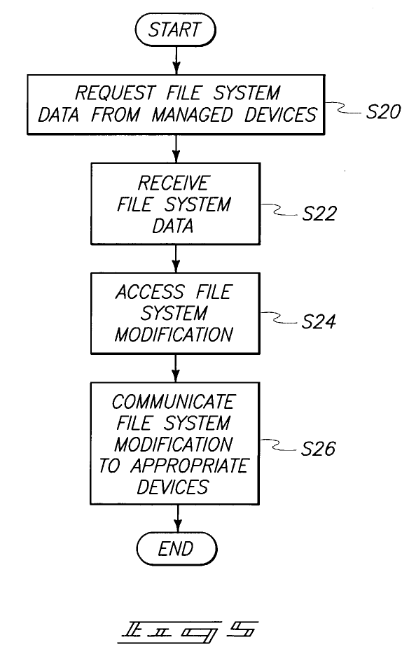

Referring to FIG. 4, an exemplary methodology executable by processing circuitry 32 of hard imaging device 16 is shown. Other methods are possible including more, less or alternative steps.

At a step S10, file system data may be communicated by the processing circuitry to a management device. The file system data may comprise information enabling the mounting of the file system by the management device. In one embodiment, the information includes NFS network protocol programming information from a remote file system server module of device 16 to a remote file system client module of device 12. Exchange of other data is provided in other embodiments or according to other protocols. The data may be communicated responsive to a request of the management device, to user action or other event.

At a step S12, a communication from the management device may be received. The communication may pertain to modification of the file system 38 responsive to the communicated data of step S10. The communication may be accessed by the processing circuitry.

At a step S14, the processing circuitry operates to process the communication.

At a step S16, the processing circuitry modifies the file system 38 responsive to processing the received communication. For example, a new file may be copied to the file system or an existing file may be modified or updated. As discussed herein, other operations with respect to modification of file system 38 are possible.

Referring to FIG. 5, an exemplary methodology executable by processing circuitry 22 of management device 12 is shown. Other methods are possible including more, less or alternative steps.

At a step S20, the processing circuitry may formulate and control communication of a request to one or more managed device (i.e., hard imaging devices 16) to initiate management operations of the devices and request file system data from the devices.

At a step S22, the processing circuitry accesses file system data received from the respective hard imaging devices. The information may be processed and the processing circuitry may operate to create the virtual file systems 26 using the received file system data.

At a step S24, the processing circuitry accesses a modification intended for the respective file systems responsive to the processing of step S22. The modification may comprise a new file to be copied, a modification to an exiting file of the file systems, new or updated programming, etc.

At a step S26, the processing circuitry communicates the modification to the respective hard imaging device(s) to implement the modification of the respective file systems. The communication of the modification may occur in a batch processing operation in one exemplary embodiment.

The protection sought is not to be limited to the disclosed embodiments, which are given by way of example only, but instead is to be limited only by the scope of the appended claims.

What is claimed is:

1. A hard imaging system comprising:
a plurality of hard imaging devices individually comprising:
a communications interface configured to communicate with a communications medium external of the respective hard imaging device;
an image engine configured to form hard images using media;
a file system configured to store a plurality of electronic files; and
processing circuitry configured to access the electronic files of the file system during the formation of the hard images; and
a management device comprising:
a communications interface configured to communicate with the communications medium and the hard imaging devices;
processing circuitry configured to access and to modify the file systems of the respective hard imaging devices.

2. The system of claim 1 wherein the processing circuitry is configured to mount the file systems of the respective hard imaging devices.

3. The system of claim 1 wherein the processing circuitry of the management device is configured to copy a new electronic file to at least one of the file systems to modify the respective file system.

4. The system of claim 1 wherein the processing circuitry of the management device is configured to modify an existing electronic file of at least one of the file systems to modify the respective file system.

5. The system of claim 1 wherein the processing circuitry of the management device is configured to modify the file systems of at least some of the hard imaging devices in a single batch operation.

6. The system of claim 1 wherein the processing circuitry of the management device is configured to provide an executable application to at least one of the file systems, and the processing circuitry of the at least one hard imaging device associated with the at least one file system is configured to recognize the executable application and execute programming of the executable application.

7. The system of claim 1 wherein the processing circuits are configured to execute network protocol programming to implement communication of data regarding the file systems between respective ones of the hard imaging devices and the management device.

8. The system of claim 1 wherein the hard imaging devices comprise printers.

9. A hard imaging management device comprising:
a communications interface configured to communicate with a communications medium and a hard imaging device external of the hard imaging management device and coupled with the communications medium, wherein the hard imaging device is configured to form hard images using media; and
processing circuitry configured to access a file system of the hard imaging device, and to modify at least a portion of the file system of the hard imaging device, wherein the modification is pertinent to hard imaging operations of the hard imaging device for forming the hard images.

10. The device of claim 9 wherein the processing circuitry is configured to mount the file system of the hard imaging device.

11. The device of claim 9 wherein processing circuitry of the hard imaging device is configured to mount the file system of the hard imaging management device.

12. The device of claim 9 wherein the processing circuitry is configured to copy a new electronic file to the file system to modify the file system.

13. The device of claim 9 wherein the processing circuitry of the management device is configured to modify an existing electronic file of the file system to modify the file system.

14. A hard imaging device comprising:
a communications interface configured to configured to communicate with a communications medium external of the hard imaging device;
an image engine configured to form hard images using media;
a file system comprising a plurality of electronic files pertinent to hard imaging operations of the hard imaging device for forming the hard images using the image engine; and
processing circuitry configured to implement communications operations of the hard imaging device with respect to a hard imaging management device coupled with the communications medium, wherein the processing circuitry is configured to output data regarding the file system to the hard imaging management device and to modify the file system responsive to a communication received from the hard imaging management device.

15. The device of claim 14 wherein the processing circuitry is configured to output the data comprising information configured to permit the file system to be mounted using the hard imaging management device.

16. The device of claim 14 wherein the processing circuitry is configured to copy a new electronic file to the file system to modify the file system.

17. The device of claim 14 wherein the processing circuitry is configured to modify an existing electronic file of the file system to modify the file system.

18. The device of claim 14 wherein the processing circuitry is configured to access the communication comprising an executable application and to automatically execute programming of the executable application without user intervention.

19. A hard imaging device comprising:
imaging means for hard imaging images using media;
storage means for storing a file system comprising a plurality of electronic files pertinent to hard imaging operations of the hard imaging device for forming the hard images using media; and
processing means for implementing communications externally of the hard imaging device including outputting data regarding the file system and receiving a communication originating externally of the hard imaging device, and for modifying the file system responsive to the communication.

20. An article of manufacture comprising:
processor-usable media comprising programming configured to cause processing circuitry of a hard imaging device to:
output data regarding a file system comprising a plurality of electronic files externally of the hard imaging device;
access a communication originating from externally of the hard imaging system;
modify the file system responsive to the accessed communication; and
control a hard imaging operation of the hard imaging device for forming a hard image using the modified file system.

21. The article of claim 20 wherein the programming comprises programming configured to cause the processing circuitry to output the data enabling a hard imaging management device to mount the file system.

22. The article of claim 20 wherein the programming comprises programming configured to cause the processing circuitry to modify an existing electronic file of the file system to modify the file system.

23. The article of claim 20 wherein the programming comprises programming configured to cause the processing circuitry to copy a new electronic file to the file system to modify the file system.

24. The article of claim 20 wherein the programming comprises programming configured to cause the processing circuitry to access the communication comprising an executable application and to automatically execute programming of the executable application without user intervention.

25. A hard imaging device operational method comprising:
providing a hard imaging device comprising a file system pertinent to forming hard images using the hard imaging device;
communicating data regarding the file system externally of the hard imaging device;
receiving a communication within the hard imaging device responsive to the communicating;
processing the communication using the hard imaging device;
modifying the file system responsive to the processing of the received communication using the hard imaging device;
accessing a portion of the file system using the hard imaging device after the modifying; and
forming hard images according to the accessed portion of the file system using the hard imaging device.

26. The method of claim 25 wherein the communicating comprises communicating information enabling mounting of the file system by a device external of the hard imaging device.

27. The method of claim 25 wherein the receiving comprises receiving the communication comprising a new electronic file, and the modifying comprises copying the new electronic file to the file system.

28. The method of claim 25 wherein the receiving comprises receiving the communication comprising a modification to an existing electronic file of the file system, and the modifying comprises modifying the existing electronic file.

29. The method of claim 25 wherein the receiving comprises receiving the communication comprising programming, and automatically executing the programming using the hard imaging device after the processing.

30. The method of claim 25 wherein the accessing comprises accessing the portion comprising a modified portion.

31. A hard imaging device configuration method comprising:
providing a hard imaging device configured to form hard images upon media;
providing a hard imaging management device;
coupling the hard imaging device and the hard imaging management device in an arrangement permitting communication of data between the hard imaging device and the hard imaging management device; and
mounting a file system of the hard imaging device using the hard imaging management device.

32. The method of claim 31 further comprising modifying the file system of the hard imaging device using the hard imaging management device after the mounting.

33. The method of claim 32 wherein the modifying comprises copying a new electronic file from the hard imaging management device to the file system of the hard imaging device.

34. The method of claim 32 wherein the modifying comprises modifying an existing electronic file of the file system.

35. The method of claim 31 wherein the mounting comprises mounting using network protocol programming.
